(19) United States
(12) Patent Application Publication
(10) Pub. No.: US 2008/0262744 A1
(43) Pub. Date: Oct. 23, 2008

(54) Systems and Methods for Tissue Engineering Tubular Biological Structures

(75) Inventors: Brian H. Wayman, Morristown, NJ (US); Raymond P. Vito, Atlanta, GA (US); Alexander Rachev, Atlanta, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 12/106,051

(22) Filed: Apr. 18, 2008

Related U.S. Application Data
(60) Provisional application No. 60/912,480, filed on Apr. 18, 2007.

(51) Int. Cl. G06F 19/00

(52) U.S. Cl. 702/19

(57) ABSTRACT

The present invention relates to systems and methods for tissue engineering. In particular, the invention is directed toward systems and methods for conditioning tubular biological structures. For example, an aspect of the present invention comprises systems and methods for uncoupling local mechanical parameters (e.g., circumferential stress, shear stress, and axial stress) from global mechanical parameters (e.g. lumen pressure, flow rate of perfusate, and longitudinal stretch of the construct) to control of local mechanical parameters for conditioning a tubular biological construct.

### RELATED APPLICATIONS

This application claims, under 35 U.S.C. § 119(e), the benefit of U.S. Provisional Application Ser. No. 60/912,480, filed 18 Apr. 2007, the entire contents and substance of which are hereby incorporated by reference as if fully set forth below.

### GOVERNMENT LICENSE RIGHTS

This invention was made with U.S. Government support under Grant Nos. 1 R01 HL70531-01 awarded by the National Institutes of Health. The U.S. Government has certain rights in the invention.

### TECHNICAL FIELD

The present invention relates to systems and methods for tissue engineering. In particular, the invention is directed toward systems and methods for conditioning tubular biological structures.

### BACKGROUND OF THE INVENTION

Tissue engineering is a rapidly growing scientific field that seeks to create, repair and replace biological tissues, structures, and organs by using combinations of cells, biomaterials, and/or biologically active molecules. Tissue engineering is an interdisciplinary field that integrates aspects of engineering, biology and medicine. Research and technology development in tissue engineering promises to revolutionize current methods of health care treatment for disease states.

One such disease state that is a target of tissue engineering is cardiovascular disease. Cardiovascular disease is the leading cause of death in the United States. Over 71 million Americans have a form of cardiovascular disease, and the annual cost of treatments associated with the disease exceeds $400 billion. One from of cardiovascular disease is atherosclerosis, which is a disorder characterized by the accumulation of plaque along the interior walls of the arteries. Obstruction the blood vessel by plaques causes a decrease in blood flow that may result in hypertension, ischemia, stroke, cardiac arrest, and death. Some plaques are also vulnerable to rupture which can lead to formation of a blood clot and subsequent stroke or heart attack.

Surgical intervention is often employed to treat atherosclerosis and may include catheterization of the vessel and using a balloon to compress the plaque, insertion of a stent within the vessel enabling the vessel to remain open, or bypass of the obstructed vessel. Bypass surgery involves the removal of a section of blood vessel, often from the patient's lower leg, and the transplantation of the vessel into the obstructed vessel by attaching the ends of the transplanted vessel above and below the obstruction of the vessel so that blood flows through the transplanted vessel and thus bypasses the obstructed vessels.

A major problem associated with bypass surgery is the patency of the transplanted vessels used as the bypass, which are prone to failure. Mechanical forces have been implicated as a major factor contributing to the failure of the bypass vessels. Mechanical forces (e.g., forces due to blood flow) are known to influence blood vessel structure through a process known as remodeling. Remodeling is the process by which arteries respond to sustained changes in their global mechanical environment, characterized by blood flow, arterial pressure, and longitudinal stretching. At the macro-level, remodeling manifests as changes in arterial dimensions and mechanical response which do not result from the deformation caused by altered loads. The effect of the mechanical environment on arterial remodeling has been studied on animal models and perfusion organ culture where arteries were subjected to controlled changes in blood flow rate, arterial pressure, or longitudinal stretch ratio for a period of several days to months. Past studies, however, cannot quantify the remodeling response caused by a controlled change in a single parameter of the local mechanical environment such as circumferential stress, flow-induced shear stress, or axial strain while keeping the remaining parameters constant. This is important because it is well known in tat arteries in vivo remodel to maintain constant levels of the local parameters. Thus, a need exists in the art for systems and methods for controlling remodeling by controlling local parameters.

### BRIEF SUMMARY OF THE INVENTION

Various embodiments of the present invention are directed a conditioned biological constructs, systems for conditioning a biological construct, and methods for conditioning a biological construct. Broadly described, a system for conditioning a biological construct comprises a global mechanical parameter measuring device for measuring at least one global mechanical parameter of the construct and a processing unit, wherein the processing unit acquires data from the global mechanical parameter measuring device and determines a local mechanical parameter of the construct. In an embodiment of the present invention, the construct can be a hollow biological construct having a lumen. The global mechanical parameter can be one of lumen pressure in the construct, flow rate of a medium through the construct, and longitudinal stretch of the construct. A local mechanical parameter can be one of mean circumferential stress on the construct, shear stress on the construct, and mean axial stress of the construct. A system for conditioning a biological construct can involve conditioning a construct from a first state to a desired second state of the construct by iteratively controlling at least one of the local mechanical parameters.

A system for conditioning a construct from a first state of the construct to a desired second state of the construct can comprise: a hollow biological construct having a lumen, wherein the hollow biological construct being in a first state; a medium traveling through the lumen of the construct; a global mechanical parameter measuring device for measuring at least one global mechanical parameter of the construct; and a processing unit, wherein the processing unit acquires data from the global mechanical parameter measuring device and determines a local mechanical parameter of the construct. The system for conditioning a construct can measure at least one global mechanical parameter, wherein a global mechanical parameter is one of lumen pressure of the construct, flow rate of a medium through the construct, and longitudinal stretch of the construct. A local mechanical parameter involved in a system for conditioning a construct can be one of mean circumferential stress of the construct, shear stress of the construct, and mean axial stress on the construct.

A system for conditioning a construct can further comprise a chamber, having at least one inlet and at least one outlet, that at least partially contains the construct, wherein the construct is oriented substantially in-line with at least one inlet and at least one outlet. A system for conditioning a construct can further comprise a reservoir for retaining the medium that is in communication with the chamber via a conduit. A system for conditioning a construct can further comprise a pump in communication with the medium of the reservoir, wherein the pump urges the medium through the hollow biological construct. By way of example, the pump can be a pulsatile pump.

The medium of a system for conditioning a construct can comprise a liquid, a gas, or a combination thereof. In a system for conditioning a construct that comprises a liquid medium, the medium can comprise a tissue culture medium, blood, a blood analog fluid, urine, a physiologically buffered saline solution, or other physiologically buffered solution.

In a system for conditioning a biological construct, the biological construct can comprise a vascular construct, a blood vessel, an artery, a vein, a lymph vessel, a ureter, an esophagus, an intestine, a duct, a fallopian tube, an Eustachian tube, a trachea, a bronchus, a bronchial tube, a tube that comprises cells, or other biocompatible substrate comprising cells.

The global mechanical parameter measuring device of the system for conditioning a construct can comprise at least one of a pressure-measuring device for measuring the lumen pressure ion the construct, a diameter measuring device for measuring the diameter of the construct, a thickness measuring device for measuring the thickness of a wall of the construct, and a force measuring device measuring the axial stretch of the construct. By way of example, a global mechanical parameter measuring device can comprise a pressure transducer, an ultrasound transducer, a camera, or a force transducer.

An embodiment of the present invention comprises a method for uncoupling a local mechanical parameter from global mechanical parameters influencing a biological construct comprising calculating a first local mechanical parameter, being mean circumferential wall stress, from at least one of the global mechanical parameters; calculating a second local mechanical parameter, being shear stress, from at least one of the global mechanical parameters; and calculating a third local mechanical parameter, being mean axial stress, from at least one of the global mechanical parameters. In a method for uncoupling a local mechanical parameter from global mechanical parameters influencing a biological construct, a global mechanical parameter is one of lumen pressure of the construct, flow rate of a medium through the construct, and longitudinal stretch of the construct.

A method for uncoupling a local mechanical parameter from global mechanical parameters influencing a biological construct can further comprise adjusting at least one of the global parameters in response to the calculation of the first local mechanical parameter, the second local mechanical parameter, and the third local mechanical parameter. A method for uncoupling a local mechanical parameter from global mechanical parameters influencing a biological construct can further comprise iteratively calculating the first local mechanical parameter, the second local mechanical parameter, and the third local mechanical parameter and adjusting at least one of the global mechanical parameters to condition a construct from a first state to a desired second state by manipulating at least one local mechanical parameter.

A method for uncoupling a local mechanical parameter from global mechanical parameters influencing a biological construct can comprise calculating the first local parameter, being the mean circumferential wall stress (σ_{θ}), by solving the formula

$${σ}_{θ} = \frac{P ( {d}_{o} - 2 h )}{2 h}$$

wherein P is transmural pressure of the construct, dₒ is an outer diameter of the construct at the loaded state, and h is a wall thickness of the construct at the loaded state. A method for uncoupling a local mechanical parameter from global mechanical parameters influencing a biological construct can comprise calculating the second local mechanical parameter being the shear stress (τ), by solving the formula

$$τ = \frac{32 μ Q}{{π ( {d}_{o} - 2 h )}^{3}}$$

wherein μ is a viscosity of a medium flowing through the construct and Q is a flow rate of the medium. A method for uncoupling a local mechanical parameter from global mechanical parameters influencing a biological construct can comprise calculating the third local mechanical parameter being the mean axial stress (σ_{z}), by solving the formula

σ_{Z}=F/πh(dₒ−h)

wherein F is an axial load born by the construct, dₒ is an outer diameter of the construct, and h is a thickness of the construct.

A method for uncoupling a local mechanical parameter from global mechanical parameters influencing a biological construct can further comprise assaying the effects of at least one of the local mechanical parameters on the biological construct. By way of example, assaying the effects of at least one of the local mechanical parameters on the biological construct can comprise analyzing cellular proliferation, apoptosis, synthesis of the extracellular matrix, protein synthesis, enzymatic activity or gene expression.

A method for uncoupling a local mechanical parameter from global mechanical parameters influencing a biological construct can be used in a system for conditioning a construct as well as to create an engineered construct.

An engineered construct of the present invention can comprise a biological construct being in a first state, wherein the biological construct is conditioned to have at least one desired physical property, wherein the at least one desired physical property is created by iterative calculation and control of at least one local mechanical parameter derived from at least one global mechanical parameter so that the biological construct is conditioned from the first state to a desired second state. In an embodiment of the present invention, a biological construct can comprise a vascular construct, a blood vessel, an artery, a vein, a lymph vessel, a ureter, an esophagus, an intestine, a duct, a fallopian tube, an Eustachian tube, a trachea, a bronchus, a bronchial tube, a tube that comprises cells, or other biocompatible substrate comprising cells.

An engineered construct of the present invention can be conditioned to possess at least one desired physical property, wherein the at least one desired physical property of the construct comprises length, width, thickness, diameter, or rigidity. An engineered construct of present invention can be conditioned from a first state to a desired second state by manipulation of at least one local mechanical parameter, and the at least one local mechanical parameter can comprise circumferential wall stress of the construct, shear stress of the construct, or axial stress of the construct.

Other aspects and features of embodiments of the present invention will become apparent to those of ordinary skill in the art, upon reviewing the following detailed description in conjunction with the accompanying figures.

### BRIEF DESCRIPTION OF DRAWINGS

FIG. 1 is a schematic of a tissue engineering system.

FIG. 2 is a flow chart illustrating a process for controlling local mechanical parameters.

FIG. 3 is a flow chart illustrating an overview of a process for a case of independently controlling circumferential stress and shear stress at a fixed axial stretch ratio in perfusion organ culture.

FIGS. 4 A-F are graphs of a timecourse of mechanical parameters for a representative experiment.

FIGS. 5 A-F are graphs of a detailed view of mechanical parameters during an iterative adjustment of pressure and flow rate for the representative experiment.

FIGS. 6 A-E are comparison of tissue morphology of transverse sections for arteries using hematoxylin and eosin staining.

FIG. 7 is a graph of matrix synthesis measured by ³H-proline incorporation for arteries.

FIGS. 8 A-B are representative SDS-PAGE zymograms for arteries exposed to high and low levels of circumferential stress (A) and shear stress (B).

FIGS. 8 C-D are graphs illustrating MMP activity for circumferential stress and shear stress experiments, respectively

FIG. 9 is a graph illustrating the percentage of proliferating cells detected by BrdU incorporation during the final 24 hours of culture.

### DETAILED DESCRIPTION

Mechanical forces (e.g., forces due to blood flow) are known to influence blood vessel structure through a process known as remodeling. Remodeling is the process by which arteries respond to sustained changes in their global mechanical environment, characterized by blood flow, arterial pressure, and longitudinal stretching. At the macro-level, remodeling manifests as changes in arterial dimensions and mechanical response which do not result from the deformation caused by altered loads. The effect of the mechanical environment on arterial remodeling has been studied in animal models and perfusion organ culture where arteries were subjected to controlled changes in blood flow rate, arterial pressure, or longitudinal stretch ratio for a period of several days to months.

Results from animal models have shown that arteries respond to altered blood flow by an acute vasomotor response directed to restore the flow-induced shear stress at the arterial lumen to homeostatic levels, followed by a chronic remodeling process. Although animal investigations maintain the artery under conditions that are close to physiological conditions, there are difficulties in precisely and continuously controlling and monitoring the mechanical environment and remodeling outputs. In addition, other factors such as neuronal stimulation and the local hormonal and metabolic environment might affect smooth muscle cell activity and wall remodeling.

To focus solely on the effects of mechanical environment, organ culture systems were studied. Organ culture systems provide conditions supporting arterial metabolism and maintaining arterial function for a period of several days up to four weeks. Organ culture systems allow independent control of the magnitude and frequency of pressure and flow rate to better evaluate their contribution to remodeling outputs. Because remodeling in response to alterations in pressure and flow takes more time than the period during which current organ culture systems can maintain smooth muscle cell viability, remodeling response is estimated by the trends of the change in the geometrical dimensions or by specific biological markers which are indicators of the proliferative, synthetic, or degradative activity of vascular cells.

Similar to animal studies, results from organ culture investigations support the conclusion that remodeling induced by alterations in global mechanical parameters is an adaptive response that maintains the local shear stress at the intima and circumferential stress and axial strain in the media to their baseline values. Stresses and strains represent the local mechanical environment of the endothelial and smooth muscle cells. It is the changes in the local mechanical factors that affect cellular processes, such as cell proliferation, apoptosis, hypertrophy, migration, and matrix synthesis and degradation, for which the combined effect ultimately leads to observed geometrical and structural responses of remodeling.

Both animal and organ culture studies performed so far have revealed many aspects of the normal and pathologic remodeling of arteries from different species, age groups, and locations within the vasculature. However, the methodology used in these studies cannot address several important issues. Past studies cannot quantify the remodeling response caused by a controlled change in a single parameter of the local mechanical environment such as circumferential stress, flow-induced shear stress, axial stress, or pulsatile circumferential stress or strain, while keeping the remaining local parameters unchanged. In general, a change in a single global parameter, which is the experimental design used in past investigations, leads to a change of several local parameters and, therefore, the remodeling response is a result of the combined changes of all local parameters. For instance, a change in the mean arterial pressure causes changes in circumferential stress, pulsatile circumferential strain, and shear stress at the endothelium. Though under physiological conditions, the arterial pressure, flow, or longitudinal stretch might vary, understanding the contribution solely of a single local mechanical factor to which the endothelial and smooth muscle cells are exposed can provide insights on the mechanisms of arterial remodeling. Quantification of the independent effects of the altered shear stress, circumferential stress, and circumferential pulsatile strain can reveal which parameter has a major remodeling effect, the possibility of a dose response, whether they synergistically contribute to the remodeling outputs, and whether there exists a causal link between a deviation from baseline value of certain local mechanical parameter and observed remodeling outputs.

Focusing on the effects on remodeling caused by alterations in global mechanical parameters, past studies did not sufficiently analyze the contribution of arterial dimensions and mechanical properties on remodeling outputs. The size and mechanical properties of vascular tissue relate changes in global mechanical environment of an artery to changes in local mechanical environment of arterial cells via equations of equilibrium. Therefore, past studies could not determine the extent of the “remodeling capacity” of endothelial and smooth muscle cells or the amount and reorganization of the extracellular matrix responsible for an observed mode of remodeling.

While constructs in a bio-reactor are currently subjected to changes in global mechanical parameters (e.g., lumen pressure, flow rate of perfusate, and longitudinal stretch of the construct), cells within the construct respond, not to pressure and flow, but rather to the related local mechanical parameters (mean circumferential stress, shear stress, and mean axial stress). Cellular responses in natural blood vessels, whose behavior is being mimicked, are well known to tend to restore local parameters to baseline levels. Dose responses to changes in local mechanical variables and synergies among them are also important. Since change in a single global parameter (e.g., pressure) results in changes of multiple local parameters (e.g., shear stress, mean circumferential stress, and axial stress), it is highly desirable to control local rather than global parameters when conditioning a tissue engineered construct in a bio-reactor. To do so, avoids confounding of the stimuli sensed by the cells and hence better predicts and controls their responses and, ultimately, the properties of the vascular substitute produced—properties which strongly influence its in vivo performance.

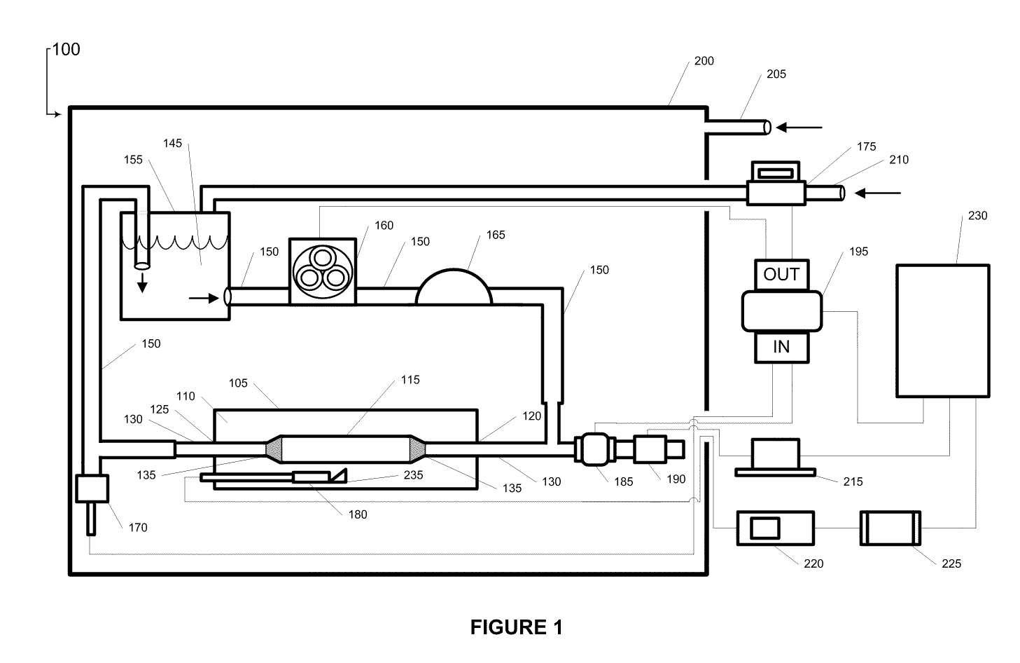

An embodiment of the present invention comprises a system for tissue engineering 100, shown schematically in FIG. 1. The system for tissue engineering 100 comprises a sample chamber 105. The sample chamber 105 generally is a sterilizable container comprising a plurality of fittings, which function to provide, for example only but not limited to, temperature probe insertion; pH probe insertion; inflow and outflow of bathing culture medium 110; inflow and outflow of one or more gases, such as, but not limited to, carbon dioxide, nitrogen, oxygen, air or other gas or gaseous mixtures (e.g., 5% CO₂ in air); media sampling port; addition of acid, base or other buffering agent for the adjustment or other control of medium pH, among others. The sample chamber 105 can be made of glass (e.g., standard laboratory grade glass), plastic (e.g., many types of sterilizable biocompatible plastics), biocompatible metal, or other appropriate material that can meet the system's requirements.

In one embodiment of the present invention, a bathing culture medium 110 can comprise a liquid. In another embodiment of the present invention, a bathing culture medium 110 may comprise a gas. A liquid bathing culture medium can be many physiologically buffered solutions, including but not limited to a tissue culture medium, blood, a blood analog fluid, physiologically buffered saline solution, or other physiologically buffered solution, as known to those skilled in the art, among others. A gas perfusion culture medium may comprise carbon dioxide, nitrogen, oxygen, air or other gas or gaseous mixtures (e.g., 5% CO₂ in air). In one embodiment of the present invention, a liquid bathing culture medium is Dulbecco's Modified Eagles Medium (DMEM). In another embodiment of the present invention, a liquid bathing culture medium is Dulbecco's Modified Eagles Medium (DMEM), which can be supplemented with sodium bicarbonate, L-glutamine, L-proline, ascorbic acid, antibiotic-antimycotic solution, and serum.

An aspect of the present invention comprises a biological sample. In one embodiment of the present invention, the sample is a tubular biological construct 115, which can comprise for example but not limited to a vascular construct, a blood vessel, an artery, a vein, lymph vessels, a ureter, an esophagus, an intestine, a duct, a fallopian tube, an Eustachian tube a trachea, a bronchus, a bronchial tube, a tube that comprises cells, or other biocompatible substrate comprising cells, among others. A tubular biological construct, as used herein, is intended to refer to the use of many tube shaped vessels, including but not limited to, linear and non-branched constructs, curved constructs, curved vessels (e.g., half a toroid), bifurcated constructs (including but not limited to branched, Y-shaped, T-shaped constructs among others), and the like.

The sample chamber comprises at least one inlet 120 and at least one outlet 125, wherein a tubular biological construct 115 connects the at least one inlet 120 to the least one outlet 125 within the sample chamber 105. Connection of the at least one inlet 120 to the tubular biological construct 115 can be facilitated by a connector member 130 and an attachment element 135. In one embodiment of the present invention, the connector member 130 can be a cannula. In one embodiment of the present invention, the attachment element 135 can be a suture. More particularly, a suture can be a purse-string suture. Connection of the at least one outlet 125 to the tubular biological construct 115 can be facilitated by a connector member 130 and an attachment element 135. In one embodiment of the present invention, the connector member 130 can be a cannula. In one embodiment of the invention, the cannula can be a stainless steel cannula. In another embodiment of the invention, the cannula can be a thin-walled stainless steel cannula. In an embodiment of the present invention, a groove can be machined on the surface cannula to facilitate mounting of the tubular biological construct. In one embodiment of the present invention, the attachment element 135 can be a suture. More particularly, a suture can be a purse-string suture. Connection of the at least one inlet 120 to the tubular biological construct 115 and connection of the at least one outlet 125 to the tubular biological construct permits the flow of a perfusion culture medium 145 from the inlet 120 through the tubular construct 115 and to the outlet 125 within the sample chamber 110.

In an embodiment of the present invention, the connector member may be associated with a motor. More particularly, the connector member may be associated with a linear motor. The motor of an embodiment of the present invention provides a means to control axial stretch, force, or stress in time or in response to measure or calculated changes in other system parameters.

The sample chamber 110 is connected by a conduit 150 to a reservoir 155 containing a perfusion culture medium 145. In an embodiment of the present invention, the conduit may comprise tubing. Tubing generally comprises many suitable types of laboratory tubing that is capable of being sterilized, including but not limited to PharMed® tubing, Tygon® vinyl tubing, silicone tubing, polyethylene tubing, Teflon tubing, rubber tubing, or other comparable laboratory-grade or medical-surgical-grade tubing, among others.

The reservoir 155 generally is a sterilizable container comprising a plurality of fittings, which function to provide, for example only but not limited to, temperature probe insertion; pH probe insertion; inflow and outflow of perfusion culture medium 145; inflow and outflow of one or more gases, such as, but not limited to, carbon dioxide, nitrogen, oxygen, air or other gas or gaseous mixtures (e.g., 5% CO₂ in air); media sampling port; addition of acid, base or other buffering agent for the adjustment or other control of medium pH, among others. The reservoir 155 can be made of glass (e.g., standard laboratory grade glass), plastic (e.g., many types of sterilizable plastics), biocompatible metal, or other appropriate material that can meet the system's requirements.

In an embodiment of the present invention, a perfusion culture medium 145 can comprise a liquid. In another embodiment of the present invention, a perfusion culture medium 145 may comprise a gas. A liquid perfusion culture medium can be many physiologically buffered solutions, including but not limited to a tissue culture medium, blood, a blood analog fluid, physiologically buffered saline solution, or other physiologically buffered solution as known to those skilled in the art, among others. In one embodiment of the present invention, a liquid perfusion culture medium is Dulbecco's Modified Eagles Medium (DMEM). In another embodiment of the present invention, a liquid perfusion culture medium is Dulbecco's Modified Eagles Medium (DMEM), which can be supplemented with sodium bicarbonate, L-glutamine, L-proline, ascorbic acid, antibiotic-antimycotic solution, serum. In an another embodiment of the present inventions, DMEM may be supplemented with sodium bicarbonate, L-glutamine, L-proline, ascorbic acid, antibiotic-antimycotic solution, serum, and Dextran®. Dextran®, for example, may be added to the perfusion culture medium to increase the viscosity of the perfusion culture medium to physiologic levels (4 cP).

In an embodiment of the present invention, the reservoir can be connected by a conduit 150 to a pump 160. A pump 160 is generally used to provide a flow of a perfusion medium 145 through the system 100, such that a perfusion culture medium 145 flows from the reservoir 155, through the conduit 150, to the pump 160, through another conduit 150, to the sample chamber 105, and through a conduit 150, returning the perfusion culture medium 145 to the reservoir 155. In another embodiment of the present invention, a perfusion culture medium 145 flows from the reservoir 155 to the sample chamber 105 by a conduit via a pump 160.

In an embodiment of the present invention, the pump 160 is a pulsatile pump. In an exemplary embodiment of the present invention, the pulsatile pump is a peristaltic roller pump. In another embodiment of the present invention, the pump 160 can be, for example but not limited to, a rotodynamic pump (e.g. centrifugal pump), a positive displacement pump (e.g., root-type pumps, reciprocating-type pumps, or compressed air-powered double-diaphragm pumps), a kinetic pump, or a gear pump, among others.

In an embodiment of the present invention, the pump 160 maintains a continuous flow rate. In another embodiment of the present invention, the pump 160 maintains a discontinuous flow rate.

In an embodiment of the present invention, the pump 160 can be a vacuum pump. In an embodiment of the present invention, the vacuum pump can provide a flow to the medium.

In an embodiment of the present invention, a noise filter 165 can be positioned along the conduit located between the pump 160 and the sample chamber 105 to dampen the noise (e.g., high frequency vibrations) created by the movements of the pump (e.g., peristaltic pump). The noise filter 165 may also be referred to herein as a pulse damper.

Factors such as the geometry of the vessel, the diameter of the vessel, the viscosity of the medium used, the internal pressure of the system, the flow rate of the medium through the vessel, and the mechanical stretch of the tubular biological construct are among the many factors that determine the local parameters of circumferential wall stress, sheer stress, and axial stress.

A system of the present invention can be used to control the mechanical forces that influence the structure and geometries of tubular vascular structures. In order to detect the mechanical forces influencing the structure and geometries of tubular vascular structures, an aspect of the present invention comprises a plurality of measuring devices or sensors. The plurality of sensors can comprise a pressure-sensing or pressure-measuring device, a diameter measuring device, a wall thickness measuring device, and a force measuring device, among others.

In an embodiment of the present invention, the pressure sensing or pressure-measuring device can be for example but not limited to a pressure transducer, a pressure catheter (e.g., a blood pressure catheter), or a pressure probe, among others. In an embodiment of the present invention, the diameter measuring device can be for example but not limited to an ultrasound transducer or a camera. In an embodiment of the present invention, the wall thickness device can be an ultrasound transducer. In an embodiment of the present invention, the force measuring device can be for example a force transducer.

A pressure-measuring device (e.g., a pressure transducer) 170 can be used for monitoring the internal pressure of the system. In an exemplary embodiment of the present invention, the pressure measuring device 170 can be placed downstream of the sample chamber 105. In another embodiment of the present invention, the pressure measuring device 170 can be placed upstream of the sample chamber 105. In yet another embodiment of the present invention, the pressure measuring device can be placed in the reservoir 155.

An aspect of the present invention comprises a resistor member 175 or pressure controller. In one embodiment of the present invention, the resistor member 175 is a clamp. In an embodiment of the present invention, the pressure measuring device 170 can be placed downstream of the sample chamber 105 and the resistor member 175 is placed between the pressure transducer 170 and the reservoir 155. In an embodiment of the present invention, a pressure controller 175 can be positioned along the conduit between the pump 160 and the sample chamber 105 to constrict the conduit thereby raising the pressure of the system. In an exemplary embodiment of the present invention, the pressure controller 175 is coupled with the reservoir 155. In an exemplary embodiment of the present invention, the pressure controller 175 comprises an inlet 210 to provide gas (e.g. CO₂) to the system, as indicated by the arrow in FIG. 1. The pressure controller 175 can be adjusted manually or by using a computer 230 to provide a mean pressure. The resistor member 175 can control the degree of occlusion of the downstream flow to achieve a desired mean pressure. Examples of resistor members suitable for use in the present invention include a gear motor controlled clamp device that controls occlusion of the downstream tubing; valves, pinch clamps or other types of manual or computer-controlled laboratory clamps.

In an embodiment of the present invention, a pressure controller 175 can be positioned along the conduit between the pump 160 and the sample chamber 105 to constrict the conduit thereby raising the pressure of the system.

In one embodiment of the present invention, a diameter measuring device 180 can be an ultrasound transducer. More particularly, the diameter measuring device 180 can be a non-contacting ultrasound transducer. In an exemplary embodiment of the present invention, the ultrasound transducer can be positioned perpendicular to the tubular biological construct. One beam passes through the construct (e.g., a pulse), differences in material densities results in peaks and beam profile alterations that are detected with the pulser/receiver 220, and are subsequently acquired and processed using a digitizer 225, which may include an oscilloscope with peak detection software and appropriate analytical software. A linear cross-sectional profile of the construct is then detected, providing the dimensions of the outer and inner walls, and consequently, wall thickness. The probe can be positioned anywhere in the test section to provide dimensions. A beam deflector 235 can be used so that the transducer may be aligned parallel to the construct and the beam directed in a direction perpendicular to the construct. Absolute and relative dimensions can be obtained, for example, relative dimensions are sufficient for monitoring diameter variations. The dimensions are monitored and acquired, via a computer 230, in real-time along with pressure, flow and other measurements. A multi-array ultrasound probe can also be used to monitor diameter variation. The diameter sensor can also utilize lasers, video imaging (e.g. a camera), magnetic resonance imaging, other imaging modalities, or can be a contacting probe, such as known to those skilled in the art.

In an embodiment of the present invention, a force measuring device 185 comprises an axial force transducer. The force measuring device (e.g., an axial force transducer) 185 can be used for monitoring the axial stress placed on the tubular biological construct. In an exemplary embodiment of the present invention, a force measuring device may be associated with a connector member 130 and/or a motor 190 associated with a connector member 130. In an embodiment of the present invention, a motor 190 may be coupled to a motor controller 215, which can be coupled to a computer 230.

In an embodiment to the present invention, a plurality of measuring devices or sensors can be coupled to an analog-to-digital (A/D) converter 195 for data acquisition and conversion of analog signals to digital numbers. The A/D converter 195 is coupled to a computer system 230 for data acquisition. Signals derived from the measuring devices can be used for monitoring, feedback control, and process-based adjustments through integrating the A/D converted 195 with a computer 230.

A system for tissue engineering 100 generally can be operated at a temperature of about 37° C., but it can be operated at temperatures ranging from about 20° C. to about 50° C. In an embodiment of the present invention, a system for tissue engineering can be operated within an incubator 200. In an embodiment of the present invention, an incubator 200 comprises at least one port 205 for the delivery of a gas (e.g. CO₂). In an exemplary embodiment of the present invention, the incubator 200 is operated at a temperature of about 37° C., wherein the atmosphere with the incubator is about 5% CO₂. In an embodiment of the present invention, a system for tissue engineering can be associated with many temperature controlling devices, for example but not limited to, incubators, water baths, refrigerators, cold rooms, warm rooms, among others.

A system for tissue engineering 100 can be operated for a duration ranging from as short as a few minutes, for example about five to about ten minutes, to more extended lengths of time, for example but limited to about 72 hours to about 168 hours. In an embodiment of the present invention, a system for tissue engineering 100 can be operated for a duration of about 5 hours to about 120 hours. In an exemplary embodiment, a system for tissue engineering 100 can be operated for a duration of about 5 hours to about 72 hours. Technical challenges limiting the duration of operation of a system for tissue engineering are continuous maintenance of cell viability and of the sterility of the system.

A system for tissue engineering 100 can be used to condition a biological construct from a first state to a second state by manipulation of a local mechanical parameter. An aspect of the present invention comprises a system for uncoupling of a local mechanical parameter, (e.g., circumferential stress and shear stress) from a global mechanical parameter (e.g., lumen pressure, flow rate of perfusate, and longitudinal stretch of the construct). In an embodiment of the present invention, uncoupling of the local mechanical parameters from the global mechanical parameters permits control of local mechanical parameters for conditioning a biological construct from a first state to a second state.

An aspect of the present invention comprises methods for uncoupling local mechanical parameters (e.g., circumferential stress, shear stress, and axial stress) from global mechanical parameters (e.g. lumen pressure, flow rate of perfusate, and longitudinal stretch of the construct). In an embodiment of the present invention, uncoupling of local mechanical parameters from global mechanical parameters permits control of local mechanical parameters for conditioning a biological construct. An embodiment of the present invention comprises a method to study or control remodeling in biological tubular constructs in response to controlled changes in the local mechanical environment. More particularly, an embodiment of the present invention comprises a method to study or control arterial remodeling in response to controlled changes in the local mechanical environment of endothelial and smooth muscle cells.

The global mechanical parameters pressure (P), flow (Q) and axial stretch (λ)—the ratio of deformed length at any time to the un-deformed axial length at the onset of conditioning—are related to the local mechanical parameters (mean circumferential stress (σ_{θ}), wall shear stress (τ), and mean axial stress (σ_{z}) by the below equations.

At a given time, t, the mean circumferential wall stress (σ_{θ}) is given by the Law of Laplace

$${σ}_{θ} = \frac{P ( {d}_{o} - 2 h )}{2 h} \qquad ( 1 )$$

where P is the transmural pressure, dₒ is the outer diameter at the loaded state, and h is the wall thickness at the loaded state. The flow-induced shear stress (τ) at the luminal surface of the tubular biological construct is

$$τ = \frac{32 μ Q}{{π ( {d}_{o} - 2 h )}^{3}} , \qquad ( 2 )$$

where μ is the viscosity of the culture medium and Q is the flow rate. The mean axial stress (σ_{z}) is given by

σ_{Z}=F/πh(dₒ−h) (3)

where F is the axial load born by the construct, dₒ is the current outer diameter and h the current thickness of the construct.

In an embodiment of the present invention, these three equations, coupled with measured data acquired from the system, can be solved simultaneously and iteratively. In an embodiment of the present invention, selection of target values for the local mechanical parameters of σ_{θ} and τ and measured values of dₒ and h, equations (1) and (2) can be used to calculate the required pressure P, the flow Q. However, it is unlikely, given these values for P and Q (and measurements of F), that the target value for the stress σ_{z} will satisfy equation (3). Thus, an iterative procedure can be implemented wherein the axial length (stretch λ) is adjusted and the axial force F measured in order satisfy equation (3). With each adjustment of the axial length (stretch λ), the values for pressure P and flow Q will change due to changes in dimensions and can be re-calculated. Continued iteration provides values for the global parameters pressure (P), flow (Q), and length (stretch λ) to achieve the specified target local parameters σ_{θ}, σ_{z}, and τ. An exemplary embodiment of the present invention comprises an iterative, computer controlled, closed loop process, considering the mutual dependence of the variables.

In an embodiment of the present invention, local mechanical parameters (e.g., circumferential stress, shear stress, and axial stress) can be uncoupled from global mechanical parameters (e.g. lumen pressure, flow rate of perfusate, and longitudinal length and stretch of the construct). In an embodiment of the present invention, uncoupling of local mechanical parameters from global mechanical parameters permits control of local mechanical parameters for conditioning a biological construct. Remodeling outputs caused by changes in the global mechanical environment can be better analyzed and predicted on the basis of the remodeling response to independently controlled local mechanical parameters.

An aspect of the present invention comprises methods for uncoupling of the local mechanical parameters, circumferential stress and shear stress, from global mechanical parameters. In an embodiment of the present invention, uncoupling of the local mechanical parameters, circumferential stress and shear stress, from global mechanical parameters permits control of local mechanical parameters for conditioning a biological construct.

In an embodiment of the present invention, given the initial dimensions of the construct, namely the un-deformed length, un-deformed outer diameter Dₒ, un-deformed wall thickness H, and the prescribed or target values of the shear stress τ, mean wall stresses σ_{θ}, and mean axial stress σ_{z}, the pressure P, flow Q, and axial force F that produce these stresses can be determined by a method comprising: calculating the global parameters from the expressions

$${P}_{1} = \frac{2 H {σ}_{θ}}{{D}_{o} - 2 H}$$

$${Q}_{1} = \frac{π τ ( {D}_{o} - 2 H )}{32 μ}$$

$${F}_{1} = π H ( {D}_{o} - H ) {σ}_{z}$$

using pressure P₁, flow Q₁ and, by adjusting the axial length, the force F₁ as a first approximation to the global parameters to be applied on the construct in the bioreactor or organ culture; recording the corresponding deformed outer diameter d₀₁ and wall thickness h₁; calculating the global parameters from the expressions

$${P}_{2} = \frac{2 {h}_{1} {σ}_{θ}}{{d}_{o 1} - 2 {h}_{1}}$$

$${Q}_{2} = \frac{πτ ( {d}_{o 1} - 2 {h}_{1} )}{32 μ}$$

$${F}_{2} = π {h}_{1} ( {d}_{o 1} - {h}_{1} ) {σ}_{z}$$

using pressure P₂, flow Q₂ and, by again adjusting the axial length, the force F₂ as the second approximation to the global parameters to be applied on the construct in the bioreactor or organ culture; record the corresponding deformed outer diameter d₀₂ and wall thickness h₂; and calculating the third approximation of the global parameters from the expressions

$${P}_{3} = \frac{2 {h}_{2} {σ}_{θ}}{{d}_{o 2} - 2 {h}_{2}}$$

$${Q}_{3} = \frac{πτ ( {d}_{o 2} - 2 {h}_{2} )}{32 μ}$$

$${F}_{3} = π {h}_{2} ( {d}_{o 2} - {h}_{2} ) {σ}_{z}$$

The above steps can be repeated. Each repetition results in an improved calculation of the approximation of the global parameters. This process is continued until the differences ΔP, ΔQ and ΔF between two successive values of pressure P, flow Q and force F are less than a prescribed admissible error (e.g. about 1%).

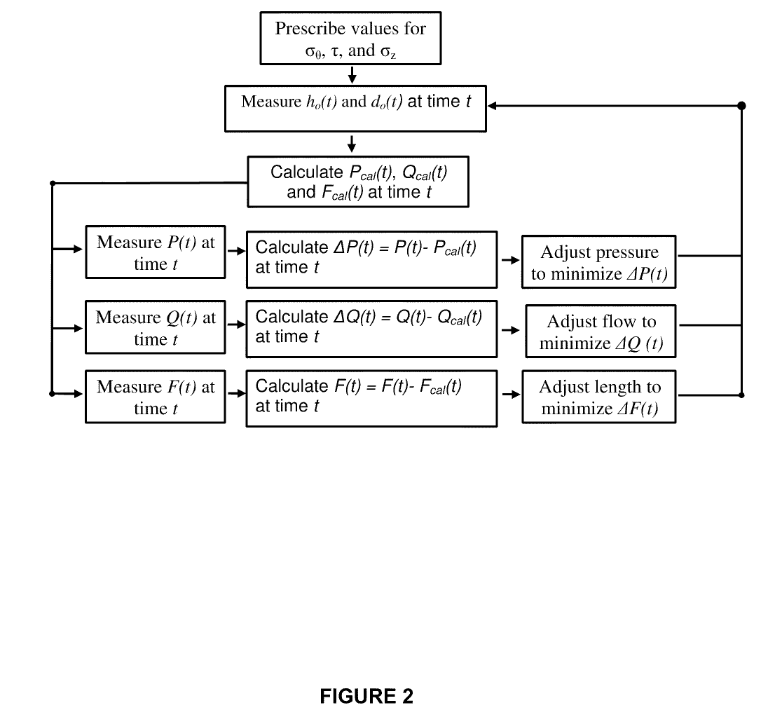

The process which describes the determination of global parameters needed to maintain the prescribed local parameters at any time t is shown schematically in FIG. 2. As can be seen from the Figure, the deformed outer diameter d₀(t), deformed thickness h₀(t) and the global parameters P(t), flow Q(t) and force F(t) are continuously measured and recorded.

The calculated global parameters P_{cal}(t), flow Q_{cal}(t) and force F_{cal}(t) at the time t that are required to produce the target values of shear stress τ, mean wall stress σ_{θ}, and mean axial stress σ_{z} are calculated from the expressions

$${P}_{cal} ( t ) = \frac{2 h ( t ) {σ}_{θ}}{{d}_{o} ( t ) - 2 h ( t )}$$

$${Q}_{cal} ( t ) = \frac{πτ ( {d}_{o} ( t ) - 2 h ( t ) )}{32 μ}$$

$${F}_{cal} ( t ) = π h ( t ) ( {d}_{o} ( t ) - h ( t ) {σ}_{z} .$$

If the difference ΔP(t) between P(t) and P_{cal}(t) or the difference ΔQ(t) between Q(t) and Q_{cal}(t), or the difference ΔF(t) between F(t) and F_{cal}(t) is more than a prescribed admissible error (e.g. about 1%) the global parameters are iteratively corrected as explained above.

Appropriate software can be used to automate data acquisition, calculating the required global parameters and for the hardware control. Since the values of local average stress are prescribed and the current dimensions of the construct are measured, the software can calculate the required global parameters needed to achieve the desired target stresses. Next, the software can measure the actual current values of the global parameters and can compare these values to the calculated values. The difference between the calculated and the measured value can be used to determine how to adjust back pressure, flow, or axial displacement. However, the resulting adjustments will change the current dimensions of the artery. Therefore, it is necessary to iteratively repeat the procedure until the mismatch is sufficiently small.

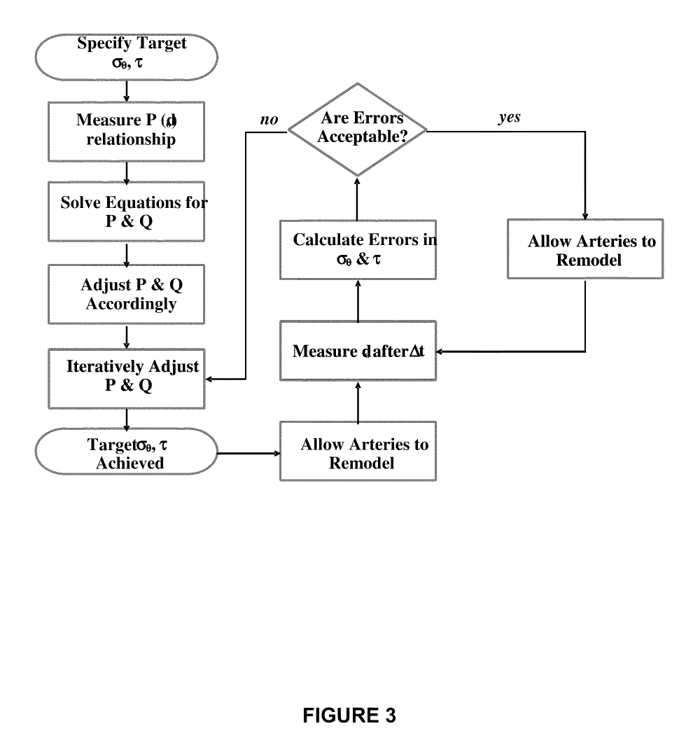

In an embodiment of the present invention, the flow chart (FIG. 3) describes a process to control circumferential and shear stress under conditions of fixed axial length in organ culture. The artery was assumed to be a circular cylinder of uniform thickness made of an elastic and incompressible material. The vessel is subjected to fully developed Poiseuille flow of a Newtonian fluid.

At a given time, t, the mean circumferential wall stress is given by the Law of Laplace

$${σ}_{θ} = \frac{P ( {d}_{o} - 2 h )}{2 h} \qquad ( 1 )$$

where P is the transmural pressure, dₒ is the outer diameter at the loaded state, and h is the wall thickness at the loaded state. The flow-induced shear stress at the luminal surface of the artery is

$$τ = \frac{32 μ Q}{{π ( {d}_{o} - 2 h )}^{3}} , \qquad ( 2 )$$

where μ is the viscosity of the culture medium and Q is the flow rate. It follows from the condition of material incompressibility that at time t the total volume of the unloaded and the deformed configurations are equal

(Dₒ−H)H=(dₒ−h)hλ (4)

where Dₒ is the unloaded outer diameter, H the unloaded wall thickness. λ is the axial stretch ratio defined as l/L, where l is the deformed vessel length at any time and L is the un-deformed axial length at the onset of conditioning.

A functional relationship between pressure and outer diameter, P=f(Dₒ), can be determined by conducting a pressure-diameter test while the artery is held at a fixed length (fixed stretch λ) and fitting to a simple quadratic function

P=Adₒ²+Bdₒ+C, (5)

where A and B are coefficients determined for a best fit to the data.

Given the target values of σ_{θ}, τ, and knowing the undeformed dimensions, Dₒ and H, as well as the axial length (stretch λ), Equations 1, 2, 4, and 5 can be solved for P, Q, dₒ, and h. The values of pressure and flow are accepted as a first guess to achieve the prescribed values of circumferential and shear stress. Once the artery is subjected to this pressure and flow rate, it is possible to measure the deformed outer diameter and to calculate the existing circumferential and shear stress from Equations 1, 2, and 4. At this point, the realized values of circumferential and shear stress may not equal their target values due to the conditions under which the pressure-diameter relationship, Equation 5, is obtained. The mechanical behavior of the artery in vivo is a result of the passive response of the elastin and collagen as well as the active response of the vascular smooth muscle. In an embodiment of the present invention, an inflation test can be performed in the absence of flow. Though Equation 5 may account for the myogenic response of the vascular muscle, it does not account for the effect of flow on the muscular tone. It is well known that flow-induced shear stress modulates the vascular tone through release of relaxing or constricting factors by the endothelial cells. Provided the difference between the existing and target values of the stresses is bigger than the admissible error, an iterative experimental approach can be applied to achieve the target values of circumferential and shear stress by iteratively imposing small variations of pressure and flow.

Generally, remodeling leads to changes in arterial dimensions and mechanical properties, and, thereby, the mechanical response of the vessel. Therefore, to maintain the prescribed values of circumferential and shear stress over time, the pressure and flow in the organ culture system must vary accordingly. The approach depends on the technical ability to determine the deformed wall thickness of the artery during an organ culture experiment. When the outer diameter and the wall thickness are monitored, the actual values of the circumferential and shear stress can be calculated at any moment and the pressure and flow can be iteratively adjusted as described above. A similar procedure is applicable if the duration of the experiment is relatively short and no significant changes in undeformed dimensions of the cultured artery are observed. Then, the current wall thickness is calculated from the measured outer diameter using the condition of material incompressibility (Equation 4). If the unloaded arterial dimensions vary but wall thickness cannot be continuously recorded, it is necessary to interrupt the experiment after a certain time interval and to measure directly the current undeformed wall thickness and outer diameter.

In an embodiment of the invention, effects of local mechanical parameters (e.g., circumferential and shear stress) on tubular biological constructs can be assayed by analyzing biological markers of remodeling. In an embodiment of the present invention, the effects of local mechanical parameters (e.g., circumferential and shear stress) on tubular biological constructs can be assayed by for example but not limited to analyzing cellular proliferation, apoptosis, synthesis of the extracellular matrix, protein synthesis, gene expression, and enzymatic activity, among others.

An aspect of the present invention comprises systems and methods directed toward the design and realization of different types of experiments focused on the effects of local mechanical parameters on tubular biological constructs (e.g., arterial remodeling). Embodiments of the present invention provide systems and methods for studying hemodynamics in normal and diseased states. Such systems and methods can promote a better understanding and prediction of the behavior of tubular biological constructs (e.g., arteries) during normal physiological conditions and pathological states.

Embodiments of the present invention comprise systems and methods for tissue engineering, including but not limited to conditioning biological constructs. Understanding the effects of local mechanical factors on remodeling can offer a scientific basis for a design of optimal mechanical conditioning in bioreactors of biological constructs (for example but not limited to, constructs with embedded cells).

Embodiments of the present invention comprise systems and methods for conditioning a biological construct from a first state to a second state.

Embodiments of the present invention comprise systems and methods for mathematical modeling of tubular biological constructs (e.g., arterial remodeling). Mathematical modeling of arterial remodeling comprises motivated selection of local mechanical parameters, whose deviation from homeostatic values are assumed to elicit specific modes of remodeling. To date, the proposed stress-growth laws and remodeling rate equations are based on an intuitive selection of the driving mechanical factors, rather than on their experimentally motivated ranking. Embodiments of the present invention can facilitate identification of significant mechanical parameters that should be taken into account when growth laws are postulated.

An aspect of the present invention comprises a tissue engineered composition, the composition comprising a tubular biological construct having at least one engineered physical property, wherein the at least one engineered physical property is created by manipulation of at least one local mechanical parameter.

In an embodiment of the present invention, a tissue engineered composition can comprise a vascular construct, a blood vessel, an artery, a vein, a lymph vessel, a ureter, an esophagus, an intestine, a duct, a fallopian tube, an Eustachian tube, a trachea, a bronchus, a bronchial tube, a tube that comprises cells, or other biocompatible substrate comprising cells, among others. A tubular biological construct, as used herein, is intended to refer to the use of many tube shaped vessels, including but not limited to, linear and non-branched constructs, curved constructs, curved vessels (e.g., half a toroid), bifurcated constructs (including but not limited to branched, Y-shaped, T-shaped constructs among others), and the like.

In an embodiment of the present invention, a biological construct can be engineered or conditioned to possess or acquire a desired physical property or a plurality of physical properties. Such physical properties can comprise length, width, thickness, thinness, rigidity (e.g. axial rigidity, circumferential rigidity), among others. In an embodiment of the present invention, a biological construct can be engineered or conditioned to possess or acquire a desired microstructure (e.g. controlled porosity or controlled diffusion, among others). In an embodiment of the present invention, the at least one local mechanical parameter for engineering or conditioning a biological construct can comprise circumferential wall stress, flow-induced shear stress, or axial stress, among others.

Other applications of the present invention include, but are not limited to, effects on cell and tissue culture in standard environments and in microgravity environments, tissue engineering, effects in complex artery geometries, effects on cardiac valves, evaluation and standardization of imagery diagnostic methods, effects of pharmacological agents on cells or tissues, and biocompatible materials testing, among others.

It must be understood that, as used in this specification and the appended claims, the singular forms “a” or “an” and “the” include plural referents unless the context clearly indicates otherwise.

All patents, patent applications, and references included herein are specifically incorporated by reference in their entireties.

It should be understood, of course, that the foregoing relates only to preferred embodiments of the present invention and that numerous modifications or alterations may be made therein without departing from the spirit and the scope of the invention as set forth in the Examples and appended claims.

The present invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention and/or the scope of the appended claims.

### EXAMPLES

### Example 1

### Materials and Methods Used Herein

EXPERIMENTAL SYSTEM AND SPECIMEN PREPARATION. The organ culture system used has been described in detail and validated in earlier studies. (1, 2) Validation included studies of endothelial and smooth muscle cell functionality after up to seven days in culture. In one embodiment, the system comprises a flow system, at least one measurement devices (camera and pressure transducer) and at least one vessel chamber connected by silicone tubing (Cole-Parmer). For example, a flow system can comprise a pump, pulse dampener, reservoir and resistance clamp, and the at least one measurement devices can comprise a camera and pressure transducer. The system was sterilized by autoclave prior to each experiment.

The media reservoir and vessel chamber were filled with sterile perfusion medium (˜500 ml) and bathing medium (˜150 ml) composed of Dulbecco's Modified Eagles Medium (DMEM) (Sigma) supplemented with sodium bicarbonate (3.7 g/L) (Sigma), L-glutamine (2 mM) (Sigma), L-proline (0.4 mM) (Sigma), ascorbic acid (50 mg/L) (Sigma), antibiotic-antimycotic solution (1%) (Sigma), and calf serum (10%) (HyClone). Dextran (6.5%) (Sigma) was added to the perfusion media to increase its viscosity to physiologic levels (4 cP).

Bilateral porcine common carotid arteries were harvested from 6 to 7-month-old farm pigs (100-150 kg) at a local abattoir, rinsed with Dulbecco's phosphate buffered saline (PBS) (Sigma) and transported to the laboratory in ice-cold PBS.

Segments having unloaded lengths of 3-5 cm were prepared under a laminar flow hood. Excess connective tissue was removed, leaks were identified using gentle inflation with air, and side branches ligated as needed. Care was taken during inflation to preserve the endothelium. A 2 mm thick ring section was cut from each end of the vessel and used to measure the unloaded cross-sectional area, outer diameter, and wall thickness. Measurements were made using a calibrated image of the backlit rings

After assembly under a laminar flow hood, arteries were oriented in the in vivo flow direction and mounted on the vessel chamber cannula using a single purse-string suture. Warm bath and perfusion media (37° C.) were added and the entire flow loop transferred to an incubator (Form a Scientific) maintained at 5% CO₂ and 37° C. for the duration of the experiment.

Flow rate was controlled using a peristaltic roller pump (Cole-Parmer) in series with a pulse dampener (Cole-Parmer). Mean perfusion pressure was controlled by a resistance clamp and was measured using a pressure transducer (Harvard Apparatus). A CCD camera (Marshall Electronics) with an adjustable zoom lens (Leica) was used to measure the outer diameter.

METHODOLOGY OF CONTROLLING LOCAL MECHANICAL ENVIRONMENT. To achieve prescribed values of circumferential and shear stress, we used a combination of an analytical and an experimental approach. First, the values of the required pressure and flow rate were determined neglecting the possible influence of flow rate on the active response of the artery. Later, precise adjustment was performed experimentally by an iterative procedure.

The flow chart depicted in FIG. 3 provides an overview of the process used to independently control circumferential and shear stress at a fixed axial stretch ratio in perfusion organ culture. The artery was assumed to be a circular cylinder of uniform thickness made of an elastic and incompressible material. The vessel is subjected to fully developed Poiseuille flow of a Newtonian fluid.

At a given time, t, the mean circumferential wall stress is given by the Law of Laplace

$${σ}_{θ} = \frac{P ( {d}_{o} - 2 h )}{2 h} \qquad ( 1 )$$

where P is the transmural pressure, dₒ is the outer diameter at the loaded state, and h is the wall thickness at the loaded state. The flow-induced shear stress at the luminal surface of the artery is

$$τ = \frac{32 μ Q}{{π ( {d}_{o} - 2 h )}^{3}} , \qquad ( 2 )$$

where μ is the viscosity of the culture medium and Q is the flow rate. It follows from the condition of material incompressibility that at time t the total volume of the unloaded and the deformed configurations are equal

(Dₒ−H)H=(dₒ−h)hλ (4)

where Dₒ is the unloaded outer diameter, H the unloaded wall thickness. λ is the axial stretch ratio defined as l/L, where l is the in situ vessel length at any time and L is the initial value of unloaded length.

A functional relationship between pressure and outer diameter, P=f(Dₒ), can be determined by conducting a pressure-diameter test while the artery is held at a fixed length (fixed stretch λ) and fitting to a simple quadratic function

P=Adₒ²+Bdₒ+C, (5)

where A and B are coefficients determined for a best fit to the data.

EXPERIMENTAL PROTOCOL. Three 3-5 cm segments were cut from bilateral porcine carotid arteries. Two of the segments were paired and used as experimental arteries while the remaining segment was used as a control to correct for changes in unloaded dimensions that occur during culture. The control vessel was required because preliminary experiments showed that the measured unloaded outer diameter and wall thickness change during the first 15 hours of culture and then remain constant. For circumferential stress studies, experimental arteries (n=10) were subjected to a circumferential stress of 50 kPa (Case A) or 150 kPa (Case B). Shear stress and the axial stretch ratio were held at physiologic levels of 1.5 Pa and 1.5, respectively.

For shear stress studies, experimental arteries (n=6) were paired and subjected to a shear stress of 0.75 Pa (Case C) or 2.25 Pa (Case D) while circumferential stress and the axial stretch ratio were held at physiologic levels of 100 kPa and 1.5, respectively. The control artery was cultured under the high circumferential or shear stress conditions because preliminary experiments showed that changes in unloaded dimensions were independent of loading conditions. For each experiment, the axial stress of both experimental vessels was equal because, at the physiologic axial stretch ratio, axial stress does not vary with pressure. All experiments were run for 3 days.

The flow loops were placed in the incubator and the flow rate was set at the minimum flow rate of 30 ml/min for approximately one hour to allow the vessels to acclimate to the organ culture environment. The vessels were then elongated in equal increments every 10 minutes to a physiologic stretch ratio of 1.5 over a period of 30 minutes.

The inflation test was then conducted to determine the pressure-outer diameter relationships. During testing, flow was stopped and the flow loop was clamped such that the vessel and the pressure transducer were isolated. Arteries were preconditioned by increasing pressure from 50 mmHg to 200 mmHg at a rate of about 5 mmHg/s for 10 cycles. Diameter measurements were taken at pressures of 50, 125, and 200 mmHg. The outer diameter measurement was acquired using a C program and the pressure data was acquired using Quick DataAcq software (Data Translation, Inc.).

Equations 1, 2, 4, and 5 were solved for the pressure and flow rate required to achieve the prescribed values of circumferential and shear stress. The pressure and flow rate were then adjusted to their target values over a 30 minute period. Pressure and flow rate were then adjusted iteratively until the prescribed values of pressure and flow rate were achieved. Circumferential and shear stress were calculated every 30 seconds using a C program. The experiment was monitored regularly and the pressure and flow rate were adjusted when the time averaged errors in circumferential or shear stress exceeded approximately 5%. Results are plotted as the time averaged value of each parameter (σ_{θ}, τ, P, Q, dₒ, and h) over 5 hours.

The control artery was cultured for approximately 15 hours and then the unloaded diameter and wall thickness were measured. From these measurements, the ratio of the unloaded dimensions at 15 h to their initial value was calculated. The corrected values of unloaded outer diameter and wall thickness for both experimental arteries were then calculated using the ratios measured for the control artery assuming the ratios are the same for all specimens. Following this, the inflation test was conducted for the experimental arteries and the Equations 1, 2, 4, and 5 were solved again for the pressure and flow rate required to achieve the prescribed stress values. Pressure and flow rate were adjusted accordingly and control of circumferential and shear stress was resumed for the remainder of the experiment.

At the end of culture, approximately 5 mm of each end of the vessel was discarded to avoid end effects and possible tissue damage due to suturing the tissue on the cannulae. The artery was then divided into sections for measurement of matrix synthesis, matrix metalloproteinase activity (MMP) activity, cell proliferation, and cell death.

ANALYSIS OF MATRIX SYNTHESIS. Matrix synthesis was measured using a ³H-proline incorporation assay based on the method of Peterkofsky and Prockop (3). Static culture, which minimizes tritium use, was used to determine the response to the stimulus applied in organ culture relative to controls. Following culture, ring segments, approximately 4 mm in length, were statically incubated in DMEM supplemented with ³H-proline (10 μCi/ml) for 18 h. The incubation period of 18 h was determined to be optimal from preliminary studies. Following radiolabelling, tissue segments were washed in quench solution [PBS supplemented with sodium sulfate (0.8 mM) and L-proline (1.0 mM) (Sigma)] four times for 30 minutes. Tissue segments that were subjected to a series of 3 freeze-thaw cycles were used as negative controls to insure that ³H-proline incorporation was due to cellular uptake and not passive diffusion. Samples were lyophilized and digested in 0.2-0.4 mg/ml proteinase K (Sigma) in 100 mM ammonium acetate solution (Sigma) overnight at 60° C. The radioactivity was measured using a scintillation counter (Tri-Carb, PerkinElmer) and results were normalized to the tissue sample's dry weight.

The activity of MMP-2 and MMP-9 were measured using SDS-PAGE zymography using a method similar to that described by Chesler et al. (4). Snap-frozen tissue samples were homogenized in ice-cold lysis buffer [10 mM sodium phosphate pH 7.2, 150 mM sodium chloride, 1% Triton X-100, 0.1% SDS, 0.5% sodium deoxycholate, 0.2% sodium azide (Sigma)] using a mechanical tissue homogenizer (Ultra-Turrax 25, IKA). The protein concentrations of the samples were measured using a modified Lowry protein assay (5). Equal amounts of protein were loaded in each lane of the gel. The gels were 10% polyacrylamide with 1.0 mg/ml of gelatin. Electrophoretic migration was carried out at 4° C. and, following migration, the proteins in the gel were renatured in a series of 2 incubations in 2.5% Triton X-100 for 15 minutes each. The gels were then incubated overnight at 37° C. in an assay buffer [50 mM Tris-HCL pH 7.4, 10 mM calcium chloride, 50 mM sodium chloride, and 0.05% Triton X-100 (Sigma)]. Following incubation, gels were stained with Coomassie Brilliant Blue (Sigma). Proteins having gelatinolytic activity were visualized as clear lysis bands while the rest of the gel was stained blue. Prestained molecular weight markers were used to determine the molecular weight of the lysis bands. ScionImage was used to quantify the zymography results based on the pixel intensity and size of the lysis band.

HISTOLOGY. Tissue samples were fixed overnight in 10% neutral buffered formalin (Fisher) and then processed for paraffin embedding. Samples were cut into 5 μm thick sections, deparaffinized, and stained using the protocols described below.

Hematoxylin and eosin (H&E) staining was used to compare the morphology of arterial tissues following culture. Sections were stained for H&E using an auto-stainer (Leica). Hematoxylin stains cell nuclei purple and eosin stains connective tissue pink. Following staining, coverslips were mounted over the sections using Cytoseal 60 mounting medium (Richard-Allan Scientific). Sections were imaged using a Nikon Eclipse E800 microscope.

ANALYSIS OF CELL PROLIFERATION. Cell proliferation was measured by using a 5-bromo-2′-deoxy-uridine (BrdU) incorporation assay described previously^{6,12}. BrdU was added to the perfusion media at a final concentration of 10 μM for the last 24 hours of culture. Following deparaffinization, BrdU epitopes were unmasked using heat induced epitope retrieval³³. Sections were permeabilized using 0.5% Triton X-100 in PBS for 20 minutes at 37° C. Slides were then incubated in primary and secondary antibodies included in the labeling kit (BrdU Labeling and Detection Kit II, Roche). Sections were incubated in 0.25 μg/ml 4′-6-Diamidino-2-phenylindole (DAPI, Sigma) in PBS for five minutes to label cell nuclei. Coverslips were then mounted using Gel/Mount (Biomeda). Sections were later visualized at 10× magnification using fluorescent microscopy. Images were taken at four equally spaced locations around the circumference of the artery for two non-serial sections. Total nuclei and BrdU-positive nuclei were counted using ImagePro Plus software (Media Cybernetics) and the ratio of labeled nuclei to total nuclei was calculated for each sample. Proliferation was calculated for each cell type within the arterial wall based on the shape and location of the cell.

Results are plotted as mean ±standard error of the mean unless stated otherwise. Paired student's t-tests were used to compare the difference between the means of the experimental groups. A p-value of less than 0.05 was considered statistically significant.

### Example 2

### Control of Local Mechanical Environment

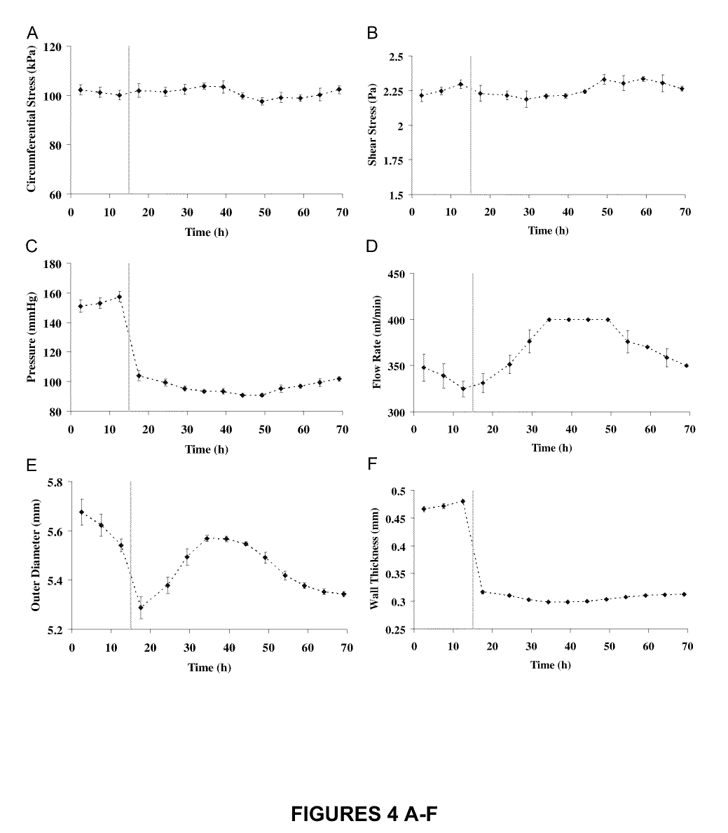

The time course of each mechanical parameter is shown in FIG. 4 for a representative case to illustrate the method of controlling the local mechanical environment. The prescribed values of mean circumferential wall stress (σ_{θ}) sheer stress (τ) and axial stretch ratio (λ) were 100 kPa, 2.25 Pa, and 1.5, respectively (Case D). The unloaded dimensions and pressure-diameter relationship of the artery were determined at the onset of the experiment and again after approximately 15 hours of culture. This process, referred to as the adjustment period, is shown in FIG. 4 as a shaded vertical line at 15 hours. Each point represents the average measurement of each parameter over 5 hours. The shaded vertical line indicates the adjustment period during which the current unloaded dimensions were determined and the inflation test was conducted. Prior to this period, circumferential and shear stress were calculated using the initial unloaded dimensions. Following this period, the stresses were calculated using the updated unloaded dimensions. Results are plotted as mean ±SD.

Significant changes of unloaded arterial dimensions that occurred during the early stage of culture were not caused by matrix synthesis or cell proliferation due to the short timeframe, but likely due to other processes that take place during culture. The change in unloaded dimensions probably results from the loss of water content due to forced diffusion in a manner similar to that described by others in which water extrusion occurred when a vessel is subjected to radial compression. The reduction of unloaded cross-sectional area of the arterial specimen was recorded in all experiments and was reported in previous studies. Therefore, if the condition of material incompressibility is used to calculate the current wall thickness from the measurements of the deformed outer diameter, it is important to account for such changes in unloaded dimensions. The finding that unloaded arterial dimensions change during culture further suggests that better comparison between results obtained in animal studies and in organ culture systems should be performed at equivalent stresses rather than at equivalent pressures and flow rates.

For the case presented (FIG. 4), the unloaded diameter and wall thickness of the artery reduced by 36.3% and 1.7%, respectively, after 15 hours of culture. Analysis of the results will be focused on data recorded after the adjustment period because, prior to this, observed changes in geometry may result from the transient changes of the unloaded dimensions.

The vessel experienced non-monotonic changes in outer diameter during culture. Following the adjustment period, the outer diameter of the artery progressively increased for about 15 hours and then gradually decreased for the remainder of the experiment. To account for these changes in outer diameter, pressure and flow rate were adjusted up to 12.7% and 20.7% to maintain circumferential and shear stress.

Following the adjustment period, when no change in unloaded dimensions occurs, the control of circumferential and shear stress is achieved by significantly varying pressure and flow rate to account for changes in arterial geometry. A plausible explanation for the observed variation of the vessel outer diameter is a change in vascular tone. When shear stress is kept at levels higher than the baseline values, the artery initially dilates, which is consistent with the results of in vivo studies on flow-induced remodeling. However, the subsequent diminishing of the outer diameter (FIG. 4) indicates that the vascular tone tends to increase over time. The response may result from the presence of FCS in the culture media in accordance with the finding that an addition of 10% FCS in the culture media induces a vasoconstrictive response in arteries in perfusion culture for four days. Therefore, the non-monotonic changes in outer diameter observed in this study likely result from a balance of the competing effects of a flow-induced relaxation of vascular smooth muscle and the contractile stimulation of FCS. The relative magnitude or timescale of each of these responses is unknown. Similar responses were observed in most arteries for all experimental conditions, although the order of dilation and constriction responses was not consistent between different experimental states.

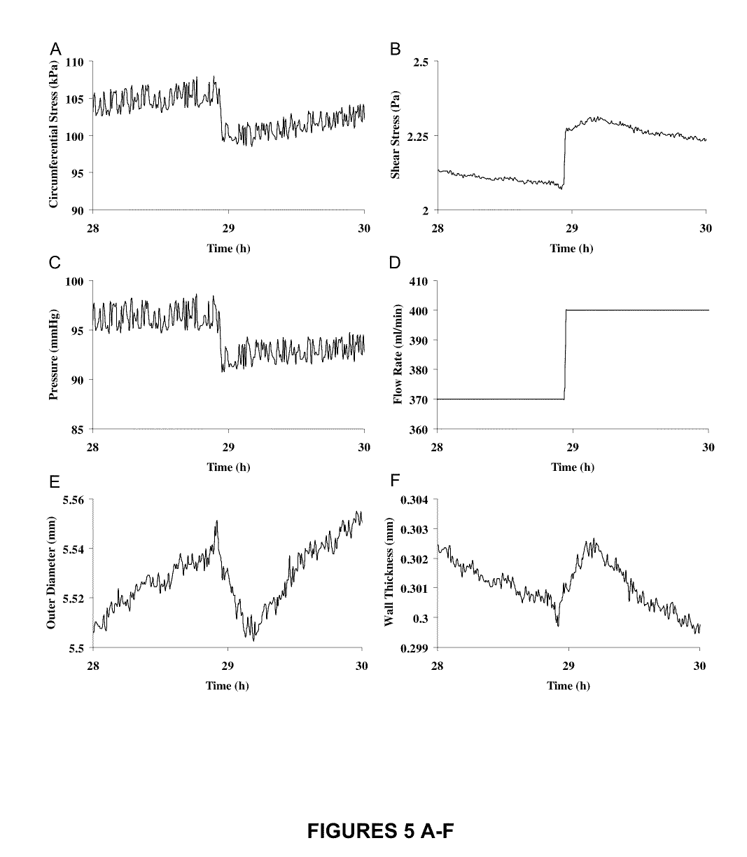

The time course of mechanical parameters measured continuously are shown during an iterative adjustment of pressure and flow rate (FIG. 5) for the representative experiment (Case D). The progressive increase in arterial outer diameter resulted in deviations of circumferential stress and shear stress from their prescribed values. In order to restore circumferential and shear stress, pressure was reduced by approximately 6.3% and flow rate was increased by 7.5%. During this iterative adjustment, circumferential stress was reduced by approximately 6.8% and shear stress was increased by approximately 8.6%, which restored the stresses to their prescribed values. The outer diameter of the artery reduced rapidly for approximately 20 minutes following adjustment of pressure and flow rate and, then, the outer diameter continued to increase as it did prior to the iterative adjustment.

Similar time courses were observed for arteries under each loading condition. In general, the pressure and flow rate required to maintain the target values of circumferential and shear stress varied considerably both between and within experiments. For example, to achieve a circumferential stress of 50 kPa, pressure ranged from 70-120 mmHg during the first 15 hours of culture and from 50-65 mmHg thereafter. To achieve a circumferential stress of 150 kPa, pressure ranged from 180-200 mmHg during the first 15 hours of culture and from 110-210 mmHg thereafter.

The variation of pressure required to maintain the target values of circumferential stress, both within and between experiments, underscores the importance of controlling local mechanical parameters in organ culture. Within an experiment, there is a dramatic change in the pressure required to maintain the desired circumferential stress before and after the adjustment period. This results from the transient changes in unloaded dimensions that occur during the first 15 hours of culture. Between experiments, the variation in the pressure required to maintain the desired circumferential stress results from the variations in geometry from animal to animal. In both cases, if the variations in geometry are not accounted for, arteries subjected to identical pressures could experience different levels of circumferential stress and flow-induced shear stress.

A significant difference in each biological marker was detected between arteries cultured at high circumferential stress (Case A) and arteries cultured at low circumferential stress (Case B). The increases in matrix synthesis at higher circumferential stress are consistent with the finding that protein synthesis increases in strips of rabbit pulmonary artery cultured at elevated wall stress under no flow conditions for 4 days. Further, this finding is consistent with the previous reports that, in response to sustained hypertension, remodeling results in thickening of arterial wall. Though an increase in pressure induces an adaptive remodeling response that restores the baseline values of circumferential stress, it is accepted that remodeling related responses are driven by the elevated circumferential stress. In this study, the stress is kept permanently elevated and the remodeling outputs could be limited by the synthetic and proliferative capacity of smooth muscle cells.

During the first 15 hours of culture, circumferential and shear stress were calculated using the initial unloaded dimensions because the unloaded dimensions of the artery change during this period. Although this results in errors in calculating circumferential and shear stress, improving the accuracy of the stress calculations requires continuous monitoring of wall thickness as with an ultrasound transducer.

### Example 3

### Response of Biological Markers of Remodeling

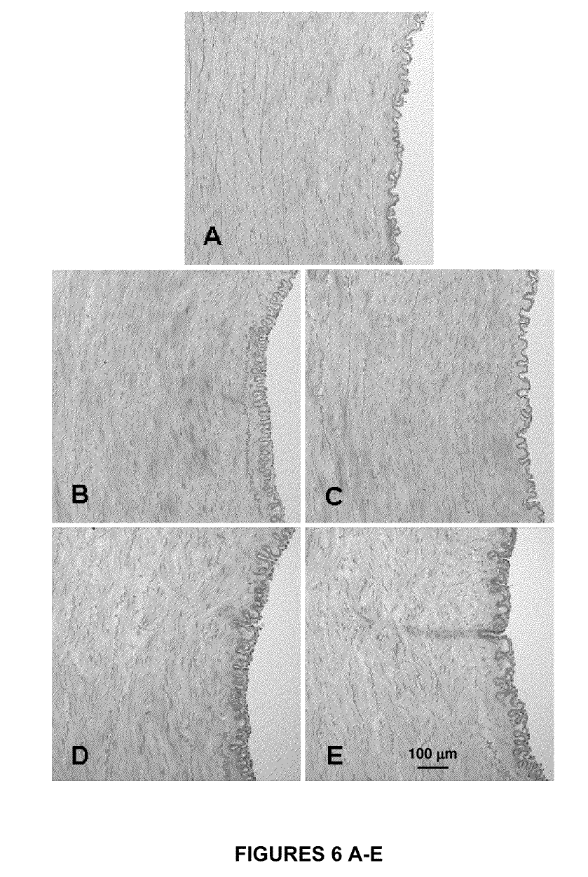

The morphology of all experimental arteries in this study was similar to that of fresh arteries (FIG. 6). FIG. 6 provides a comparison of tissue morphology of transverse sections for arteries using hematoxylin and eosin staining. Representative samples of a fresh (A) artery and vessels subjected to low circumferential stress (B), high circumferential stress (C), low shear stress (D), high shear stress (E) are shown. The lumen is on the right in each image. For each loading condition, the arteries generally maintained an intima comparable to that of fresh arteries with an intact endothelial cell layer and internal elastic lamina. In the media, the smooth muscle cells are oriented circumferentially and the extracellular matrix retains its structural integrity.

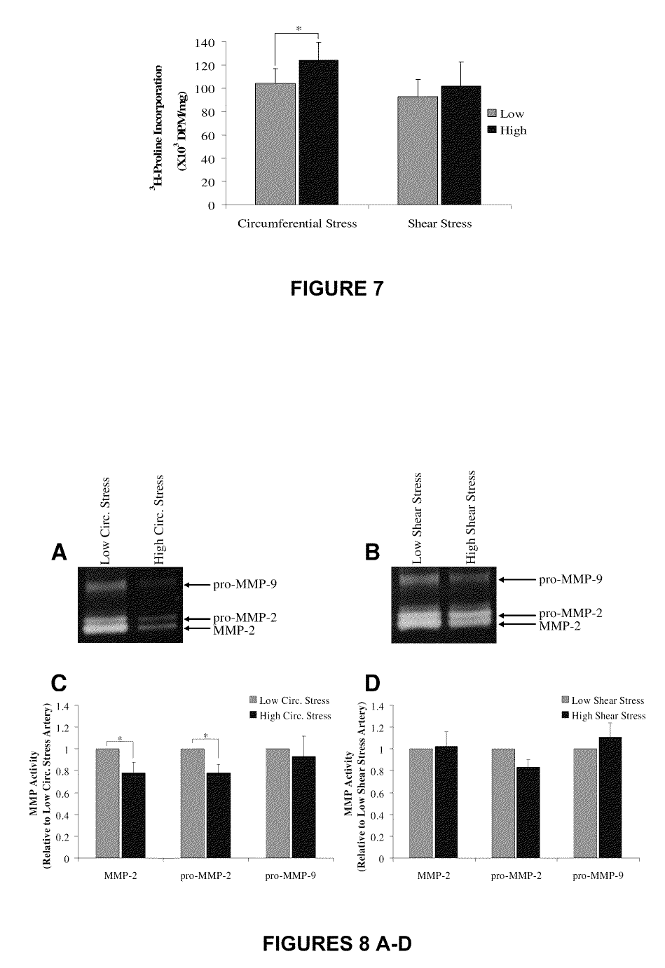

Matrix synthesis was measured by ³H-proline incorporation for arteries. As indicated in FIG. 7, for one set of experiments, arteries were exposed to low (50 kPa, Case A) or high (150 kPa, Case B) circumferential stress (n=10). For the other experiments, arteries were either exposed to low (0.75 Pa, Case C) or high (2.25 Pa, Case D) shear stress (n=6). Incorporation is measured in units of disintegrations per minute (DPM) per mg of tissue dry weight. *p<0.05. The mean value of ³H-proline incorporation for arteries (n=10) subjected to high circumferential stress was significantly greater than for low circumferential stress vessels (p<0.04) (FIG. 7). In contrast, there were no significant differences in the ³H-proline incorporation levels of high and low shear stress arteries (n=6).

The effect of circumferential (n=9) and shear stress (n=6) on MMP-2/9 gelatinolytic activity was measured using SDS-PAGE zymography. Representative zymograms for arteries exposed to high and low levels of circumferential stress (A) and shear stress (B) showing MMP-2 (67 kDa), pro-MMP-2 (72 kDa), and pro-MMP-9 (92 kDa) activity as clear lysis bands are shown in FIG. 8. Gelatinase activity was determined by densitometric analysis for circumferential stress (C) and shear stress (D) experiments. *p<0.05. Mean relative MMP-2 and pro-MMP-2 activity levels in arteries exposed to high circumferential stress were significantly less than in arteries exposed to low circumferential stress, respectively (p<0.05) (FIG. 8). Changes in circumferential stress did not significantly affect the levels of pro-MMP-9 activity. Shear stress did not significantly affect the activity of MMP-2, pro-MMP-2, or pro-MMP-9.

The effect of circumferential stress on MMP-2 and pro-MMP-2 activity is consistent with the finding that MMP-2 activity in arteries subjected to a pressure of 200 mmHg is about 70% less than that of arteries held at a 100 mmHg over a 48 hour culture period. However, in that study, MMP-9 levels were significantly greater in hypertensive arteries which was not observed in this study where pro-MMP-9 activity was unaffected by circumferential stress. The reason for the discrepancy in the MMP-9 results may be attributable to the differences in culture time. Because MMPs are involved in matrix degrading processes, the artery is essentially acting to limit tissue degradation and, therefore, contributing to a net increase in tissue content by reducing MMP-2 activity in response to elevated circumferential stress

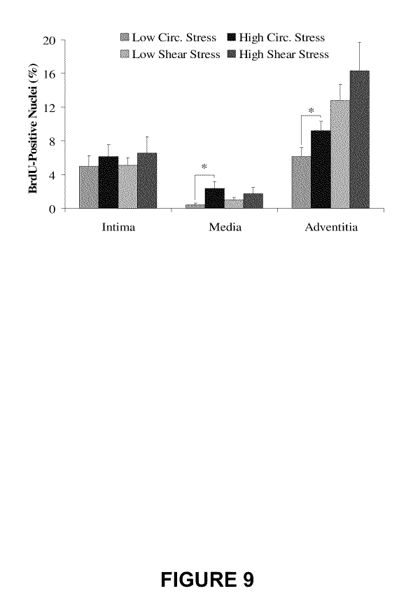

FIG. 9 demonstrates the percentage of proliferating cells detected by BrdU incorporation during the final 24 hours of culture. Arteries were subjected to low and high levels of circumferential (n=8) or shear (n=6) stress. *p<0.05. In general, the percentage of proliferating cells was greater in the intimal and adventitial layers than for in the media (FIG. 9). In experiments varying circumferential stress, there was an approximately four-fold increase in proliferation for cells in the media and an approximately 50% increase for cells in the adventitia at high circumferential stress relative to low circumferential stress arteries (p<0.05). In shear stress experiments no significant difference in proliferation for cells in any region.

The increases in proliferation of medial and adventitial cells at high circumferential stress are consistent with the increase in proliferation reported for arterial strips under elevated wall stress in static culture. The observation that cell proliferation is higher in intimal and adventitial cells than in medial cells is also consistent with previous findings.

In contrast to circumferential stress, flow-induced shear stress does not, in the short term, have a significant effect on the measured biological markers of remodeling. The results for MMP-2 activity in response to changes in shear stress are consistent with the finding that MMP-2 activity was not statistically different in arteries cultured at 0.15 and 1.5 Pa after 48 hours in culture, a response that was independent of pressure. In that study, MMP-9 was not affected by shear stress at a pressure of 100 mmHg, but increased with shear stress at a pressure of 200 mmHg.

The apparent lack of remodeling response to changes in shear stress may be due to several factors. Given the wide range of physiologic shear stresses, it is possible that the values of shear stress used in this study were not extreme enough to induce a remodeling response. Normal physiologic shear stresses can range from 1.0 to 7.0 Pa depending on location within the vasculature. In this study, arteries were exposed to shear stresses of 0.75 Pa and 2.25 Pa, values that are 50% less and greater than 1.5 Pa, the level of shear stress that is typically considered physiologic in experiments. In addition, remodeling in response changes in flow is generally a slower process compared to pressure induced remodeling. It is possible that 72 hour culture period is not sufficient to indicate detectible changes caused by wall remodeling. Finally, a remodeling response may depend on the magnitude of circumferential stress experienced by the smooth muscle cells after flow-induced changes in the shear stress sensed by the endothelial cells. Abnormal circumferential stress in combination with flow-induced alterations in the contractile state of the vascular smooth muscle may elicit remodeling response. According to the above results, circumferential and shear stress differentially affect several biological markers of remodeling.

### REFERENCES

1. Davis, N. P., H. C. Han, B. Wayman and R. Vito. Sustained axial loading lengthens arteries in organ culture. Ann Biomed Eng. 33(7):867-877, 2005.
2. Han, H. C., D. N. Ku and R. P. Vito. Arterial wall adaptation under elevated longitudinal stretch in organ culture. Ann Biomed Eng. 31:403-411, 2003.
3. Peterkofsky, B. and D. J. Prockop. A method for the simultaneous measurement of the radioactivity of proline-C14 and hydroxyproline-C14 in biological materials. Anal Biochem. 4:400-406, 1962.
4. Chesler, N. C., D. N. Ku and Z. S. Galis. Transmural pressure induces matrix-degrading activity in porcine arteries ex vivo. Am J. Physiol. 277(5 Pt 2):H2002-2009, 1999.
5. Lowry, O. H., N. J. Rosebrough, A. L. Farr and R. J. Randall. Protein measurement with the Folin phenol reagent. J Biol. Chem. 193(1):265-275, 1951.

What is claimed is:

1. A system for engineering a construct comprising:
a global mechanical parameter measuring device for measuring at least one global mechanical parameter of the construct; and
a processing unit, wherein the processing unit acquires data from the global mechanical parameter measuring device and determines a local mechanical parameter of the construct.

2. The system of claim 1, wherein the construct is a hollow biological construct having a lumen, wherein a global mechanical parameter is one of lumen pressure in the construct, flow rate of a medium through the construct, and longitudinal stretch of the construct, and wherein a local mechanical parameter is one of mean circumferential stress on the construct, shear stress on the construct, and mean axial stress of the construct.

3. The system of claim 2, wherein the construct is conditioned from a first state of the construct to a desired second state of the construct by iteratively controlling at least one of the local mechanical parameters.

4. A system for conditioning a construct from a first state of the construct to a desired second state of the construct, the system comprising:
a hollow biological construct having a lumen, the hollow biological construct being in a first state;
a medium traveling through the lumen of the construct;
a global mechanical parameter measuring device for measuring at least one global mechanical parameter of the construct; and
a processing unit, wherein the processing unit acquires data from the global mechanical parameter measuring device and determines a local mechanical parameter of the construct.

5. The system of claim 4, wherein the medium comprises a tissue culture medium, blood, a blood analog fluid, urine, a physiologically buffered saline solution, or other physiologically buffered solution.

6. The system of claim 4, wherein the hollow biological construct comprises a vascular construct, a blood vessel, an artery, a vein, a lymph vessel, a ureter, an esophagus, an intestine, a duct, a fallopian tube, an Eustachian tube, a trachea, a bronchus, a bronchial tube, a tube that comprises cells, or other biocompatible substrate comprising cells.

7. The system of claim 4, wherein a global mechanical parameter is one of lumen pressure of the construct, flow rate of the medium through the construct, and longitudinal stretch of the construct.

8. The system of claim 4, wherein a local mechanical parameter is one of mean circumferential stress on the construct, shear stress on the construct, and mean axial stress of the construct.

9. The system of claim 4, wherein the global mechanical parameter measuring device comprises at least one of a pressure-measuring device for measuring the lumen pressure in the construct, a diameter measuring device for measuring the diameter of the construct, a thickness measuring device for measuring the thickness of a wall of the construct, and a force measuring device measuring the axial stretch of the construct.

10. The system of claim 4, wherein the global mechanical parameter measuring device comprises a pressure transducer, an ultrasound transducer, a camera, or a force transducer.

11. A method for uncoupling a local mechanical parameter from global mechanical parameters influencing a biological construct comprising:
calculating a first local mechanical parameter, being mean circumferential wall stress, from at least one of the global mechanical parameters;
calculating a second local mechanical parameter, being shear stress, from at least one of the global mechanical parameters; and
calculating a third local mechanical parameter, being mean axial stress, from at least one of the global mechanical parameters.

12. The method of claim 11, wherein a global mechanical parameter is one of lumen pressure of the construct, flow rate of a medium through the construct, and longitudinal stretch of the construct.

13. The method of claim 11 further comprising adjusting at least one of the global parameters in response to the calculation of the first local mechanical parameter, the second local mechanical parameter, and the third local mechanical parameter.

14. The method of claim 13 further comprising iteratively calculating the first local mechanical parameter, the second local mechanical parameter, and the third local mechanical parameter and adjusting at least one of the global mechanical parameters to condition a construct from a first state to a desired second state by manipulating at least one local mechanical parameter.

15. The method of claim 11, comprising calculating the first local parameter, being the mean circumferential wall stress (σ_{θ}), by solving the formula
$${σ}_{θ} = \frac{P ( {d}_{o} - 2 h )}{2 h}$$
wherein P is transmural pressure of the construct, dₒ is an outer diameter of the construct at the loaded state, and h is a wall thickness of the construct at the loaded state.

16. The method of claim 11, comprising calculating the second local mechanical parameter being the shear stress (τ), by solving the formula
$$τ = \frac{32 μ Q}{{π ( {d}_{o} - 2 h )}^{3}}$$
wherein μ is a viscosity of a medium flowing through the construct and Q is a flow rate of the medium.

17. The method of claim 11, comprising calculating the third local mechanical parameter being the mean axial stress (σ_{z}), by solving the formula
σ_{Z}=F/πh(dₒ−h)
wherein F is an axial load born by the construct, dₒ is an outer diameter of the construct, and h is a thickness of the construct.

18. The method of claim 11, further comprising assaying the effects of at least one of the local mechanical parameters on the biological construct.

19. The method of claim 18, wherein assaying the effects of at least one of the local mechanical parameters on the biological construct comprises analyzing cellular proliferation, apoptosis, synthesis of the extracellular matrix, protein synthesis, enzymatic activity or gene expression.

20. An engineered construct comprising a biological construct being in a first state, wherein the biological construct is conditioned to have at least one desired physical property, wherein the at least one desired physical property is created by iterative calculation and control of at least one local mechanical parameter derived from at least one global mechanical parameter so that the biological construct is conditioned from the first state to a desired second state.

21. The engineered construct of claim 20, wherein the biological construct comprises a vascular construct, a blood vessel, an artery, a vein, a lymph vessel, a ureter, an esophagus, an intestine, a duct, a fallopian tube, an Eustachian tube, a trachea, a bronchus, a bronchial tube, a tube that comprises cells, or other biocompatible substrate comprising cells.

22. The engineered construct of claim 20, wherein the at least one desired physical property of the construct comprises length, width, thickness, diameter, or rigidity.

23. The engineered construct of claim 20, wherein the at least one local mechanical parameter comprises circumferential wall stress of the construct, shear stress of the construct, or axial stress of the construct.
